(19) United States
(12) Patent Application Publication
(10) Pub. No.: US 2026/0159336 A1
(43) Pub. Date: Jun. 11, 2026

(54) PALLET TRANSFER MECHANISM AND PALLET TRANSFER SYSTEM

(71) Applicant: ALLY LOGISTIC PROPERTY CO., LTD., Taipei City (TW)

(72) Inventors: CHIEN-TAI CHANG, Taipei City (TW); PEI-CHIA LIU, Taipei City (TW); KAI-LUN LIN, Taipei City (TW); YU-CHEN KUO, Taipei City (TW); CHI-HAO WANG, Taipei City (TW); SHIH-HSUAN KUO, Taipei City (TW); HAI-LUN YANG, Taipei City (TW)

(21) Appl. No.: 19/234,303

(22) Filed: Jun. 11, 2025

(30) Foreign Application Priority Data
Dec. 11, 2024 (TW) 113148129

(51) Int. Cl. B65G 47/66; B65G 1/04; B65G 1/137; B66F 9/06; B66F 9/075

(52) U.S. Cl. CPC B65G 47/66; B65G 1/0407; B65G 1/1378; B66F 9/063; B66F 9/0755

(57) ABSTRACT

A pallet transfer mechanism for allowing different transportation devices to hand over a pallet includes a placement device, an obstacle sensor, and a pallet sensor. The placement device has a plurality of brackets. The obstacle sensor is disposed on one of the brackets and emits an obstacle sensing beam in a diagonal direction across the handover space toward another one of the diagonally disposed brackets. The obstacle sensing beam is used to determine whether there is an object within the handover space. The pallet sensor is disposed on one of the brackets, and emits a pallet sensing beam in a horizontal direction toward another one of the adjacent brackets. The pallet sensing beam is used to determine whether the pallet is placed on the placement member.

### BACKGROUND OF THE DISCLOSURE

### 1. Field of the Disclosure

The present disclosure relates to transfer mechanism and systems, and more particularly, to a pallet transfer mechanism and pallet transfer system.

### 2. Description of the Related Art

Conventionally, the most common method for accessing pallets in an automated storage and retrieval system is to connect the loading and unloading port of a stacker crane to a conveyor belt. In such approach, to meet the requirements for the stacker crane to receive and deliver pallets, the number of conveyor belts installed therein is usually twice the number of stacker cranes. Also, based on the practical requirements for access efficiency, additional conveyor belts are allowed to be added and connected with the input and output ports of pallets. Such method requires the user to invest heavily in large-scale equipment during the initial stage. Further, after the completion of plans and construction of all conveyor lines, the overall structure is difficult to relocate or expand, thereby reducing the flexibility in adjustments of warehouse space and operational efficiency in the future.

### SUMMARY OF THE DISCLOSURE

The present disclosure aims at resolving the issues of excessively high construction costs for transportation mechanisms and the lack of flexibility in overall spatial arrangement in conventional automated storage and retrieval systems.

For achieving the aforementioned objectives, the present disclosure provides a pallet transfer mechanism for placing a pallet and allowing different transportation devices to hand over the pallet, the pallet transfer mechanism comprises:
a placement device having a plurality of brackets arranged in a circular manner at intervals to form a handover space, each of the brackets having a support member and a placement member, the placement member disposed on a top end of the support member and configured to place the pallet;
an obstacle sensor disposed on the support member of one of the brackets, the obstacle sensor emitting an obstacle sensing beam in a diagonal direction across the handover space toward another one of the diagonally disposed brackets, the obstacle sensing beam being used to determine whether there is an object within the handover space, and the obstacle sensor accordingly sending an obstacle-existing signal or a no-obstacle signal; and
a pallet sensor disposed on the placement member of one of the brackets, the pallet sensor emitting a pallet sensing beam in a horizontal direction toward another one of the adjacent brackets, the pallet sensing beam being used to determine whether the pallet is placed on the placement member, and the pallet sensor accordingly sending a pallet-existing signal or a no-pallet signal.

Also, the present disclosure provides a pallet transfer system for different transportation devices to hand over the pallet, the transportation device comprising an automated guided vehicle and a stacker crane, the pallet transfer system comprising:
a pallet transfer mechanism disposed at an inbound position or an outbound position, the pallet transfer mechanism comprising:
   a placement device having a plurality of brackets arranged in a circular manner at intervals to form a handover space, the brackets being used to place the pallet thereon, each of the brackets having a support member and a placement member, the placement member disposed on a top end of the support member and configured to place the pallet thereon;
   an obstacle sensor disposed on one of the brackets, the obstacle sensor emitting an obstacle sensing beam in a diagonal direction across the handover space toward another one of the diagonally disposed brackets, the obstacle sensing beam being used to determine whether there is an object within the handover space, and the obstacle sensor accordingly sending an obstacle-existing signal or a no-obstacle signal; and
   a pallet sensor disposed on one of the brackets, the pallet sensor emitting a pallet sensing beam in a horizontal direction toward another one of the adjacent brackets, the pallet sensing beam being used to determine whether the pallet is placed on the placement member, and the pallet sensor accordingly sending a pallet-existing signal or a no-pallet signal;
a control module coupled with the obstacle sensor and the pallet sensor; when the control module is used to control the pallet transfer mechanism at the inbound position, if the control module receives the no-obstacle signal and the no-pallet signal, the control module outputs an automated guided vehicle inbound pallet placement signal; if the control module receives the no-obstacle signal and the pallet-existing signal, the control module outputs a stacker crane inbound pallet pickup signal; when the control module is used to control the pallet transfer mechanism at the outbound position, if the control module receives the no-obstacle signal and the no-pallet signal, the control module outputs a stacker crane outbound pallet placement signal; if the control module receives the no-obstacle signal and the pallet-existing signal, the control module outputs an automated guided vehicle outbound pallet pickup signal; and
an execution module coupled with the obstacle sensor, the pallet sensor, and the control module, the execution module configured to receive the automated guided vehicle inbound pallet placement signal, the automated guided vehicle outbound pallet pickup signal, the stacker crane inbound pallet pickup signal, and the stacker crane outbound pallet placement signal, and accordingly control operation of the automated guided vehicle and the stacker crane.

With such configuration, the pallet transfer mechanism of the present disclosure does not have a physical connection with the aforementioned transportation devices, allowing for positional adjustments according to practical needs and the available space of the automated storage and retrieval system, providing greater flexibility in warehouse space adjustment and utilization, thereby improving the overall efficiency of cargo transportation.

Furthermore, the modules of the pallet transfer system in the present disclosure work in a stable and precise collaboration to control the movement and operation of various transportation devices, ensuring a higher level of transportation and transfer accuracy of the pallet.

### BRIEF DESCRIPTION OF THE DRAWINGS

FIG. 1 is a perspective view of the pallet transfer mechanism in accordance with an embodiment of the present disclosure.

FIG. 2 is a schematic view of the operation status of the pallet transfer mechanism in accordance with an embodiment of the present disclosure, illustrating the path of the sensing beam.

FIG. 3 is a schematic view of the operation status of the pallet transfer mechanism in accordance with an embodiment of the present disclosure, illustrating the position of the positioning point.

FIG. 4 is a perspective view of the pallet transfer mechanism in accordance with another embodiment of the present disclosure.

FIG. 5 is a schematic view of the operation status of the pallet transfer mechanism in accordance with another embodiment of the present disclosure.

FIG. 6 is a schematic view of the connection relationship of the pallet transfer system in accordance with an embodiment of the present disclosure.

### DETAILED DESCRIPTION OF THE DISCLOSURE

The aforementioned and further advantages and features of the present disclosure will be understood by reference to the description of the preferred embodiment in conjunction with the accompanying drawings where the components are illustrated based on a proportion for explanation but not subject to the actual component proportion.

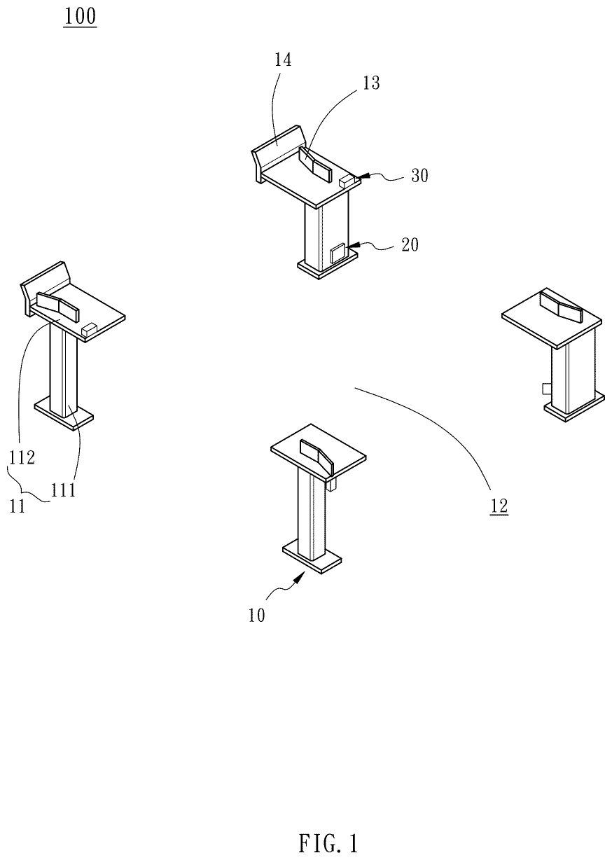

Referring to FIG. 1 to FIG. 6, the present disclosure provides a pallet transfer mechanism 100 for placing a pallet 1 thereon and allowing different transportation devices to hand over the pallet 1. The pallet transfer mechanism 100 comprises a placement device 10, an obstacle sensor 20, and a pallet sensor 30. Therein, the transportation devices include an automated guided vehicle (AGV), a stacker crane (machine for transporting cargos in an automated storage and retrieval system(ASRS)), and a forklift. The pallet transfer mechanism 100 is allowed to be disposed at an inbound position or an outbound position of the storage space of the ASRS for the automated guided vehicle and the stacker crane to hand over the pallet 1 (for the inbound operation which puts the pallet 1 into the ASRS or for the outbound operation which takes out the pallet 1 from the ASRS) or disposed at a shipping position out of the storage space of the ASRS for the automated guided vehicle and the stacker crane to hand over the pallet 1 (for the shipping operation which transports the pallet 1 to a target location out of the ASRS).

The placement device 10 comprises a plurality of brackets 11 arranged in a circular manner at intervals to form a handover space 12. Each of the brackets 11 has a support member 111 and a placement member 112. The placement member 112 disposed on a top end of the support member 111 and configured to place the pallet 1 thereon. Therein, in the embodiment, four brackets 11 are included and disposed in a square shape arrangement, so that the four brackets 11 are able to support the four corners of the pallet 1, stabilizing the placement of the pallet 1.

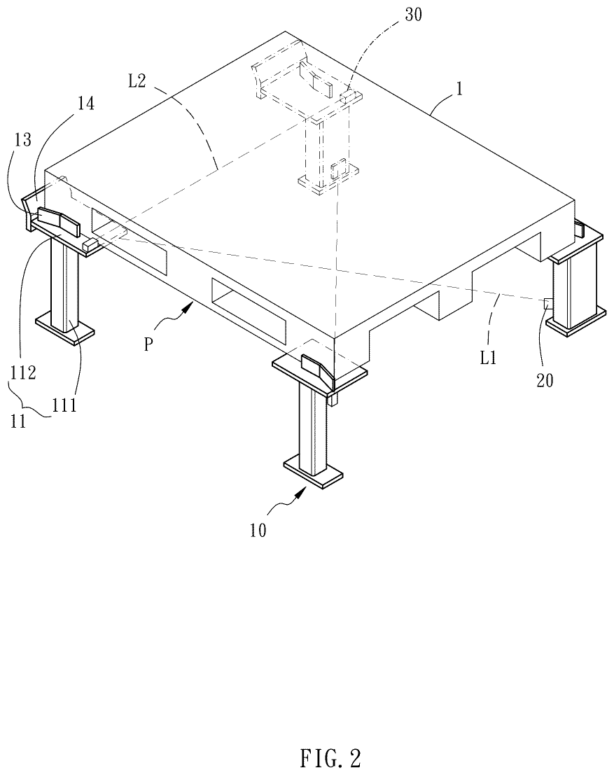

Referring to FIG. 1 and FIG. 2, in the embodiment, the placement device 10 comprises a plurality of guidance members 13 and a block member 14. Each guidance member 13 is vertically disposed on each corresponding placement member 112. The guidance members 13 are used to restrict the pallet 1 at a handover position P. The block member 14 is vertically disposed on one side of the periphery of the placement member 112, so as to restrict the pallet 1 at the handover position P. Therefore, the guidance members 13 and the block member 14 enable the pallet 1 to be stably placed at the handover position P, facilitating the transportation performance of the pallet 1 by the transportation devices.

The obstacle sensor 20 is disposed on the support member 111 of one of the brackets 11. The obstacle sensor emits an obstacle sensing beam L1 in a diagonal direction across the handover space 12 toward another one of the diagonally disposed brackets 11. The obstacle sensing beam L1 is used to determine whether there is an object within the handover space 12, and the obstacle sensor 20 accordingly sends an obstacle-existing signal or a no-obstacle signal. Therein, if the obstacle sensing beam L1 detects an object in the handover space 12 (i.e., the light beam is blocked by the object and unable to reach the other bracket 11), the obstacle sensor 20 sends the obstacle-existing signal; if no object is detected, the obstacle sensor 20 sends the no-obstacle signal.

Referring to FIG. 1 and FIG. 2, in the embodiment, two obstacle sensors 20 are included and disposed on the support member 111 of two adjacent brackets 11. The two obstacle sensing light beams L1 are emitted in a crossed pattern, so that when one of the obstacle sensing light beams L1 detects an object in the handover space 12, the corresponding obstacle sensor 20 sends the obstacle-existing signal. Through the crossed emission of the obstacle sensing light beams L1, the presence of an object in the handover space 12 is detected more accurately.

The pallet sensor 30 is disposed on the placement member 112 of one of the brackets 11. The pallet sensor 30 emits a pallet sensing beam L2 in a horizontal direction toward another one of the adjacent brackets 11. The pallet sensing beam L2 is used to determine whether the pallet 1 is placed on the placement member 112, and the pallet sensor 30 accordingly sends a pallet-existing signal or a no-pallet signal. Therein, if the pallet sensing beam L2 detects the pallet 1 on the placement member 112 (i.e., the light beam is blocked by a corner pillar of the pallet 1 on the placement member 112), the pallet sensor 30 sends the pallet-existing signal; if no pallet 1 is detected, the pallet sensor 30 sends the no-pallet signal.

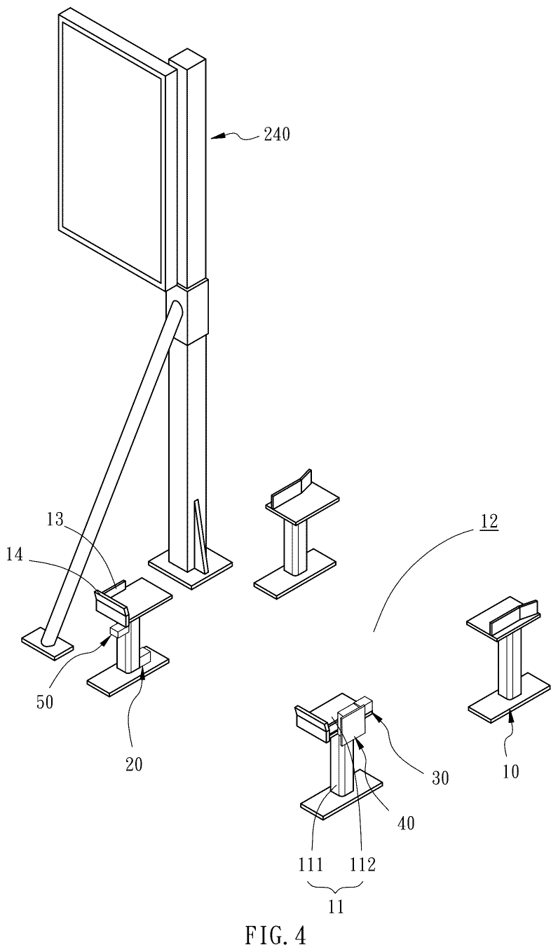

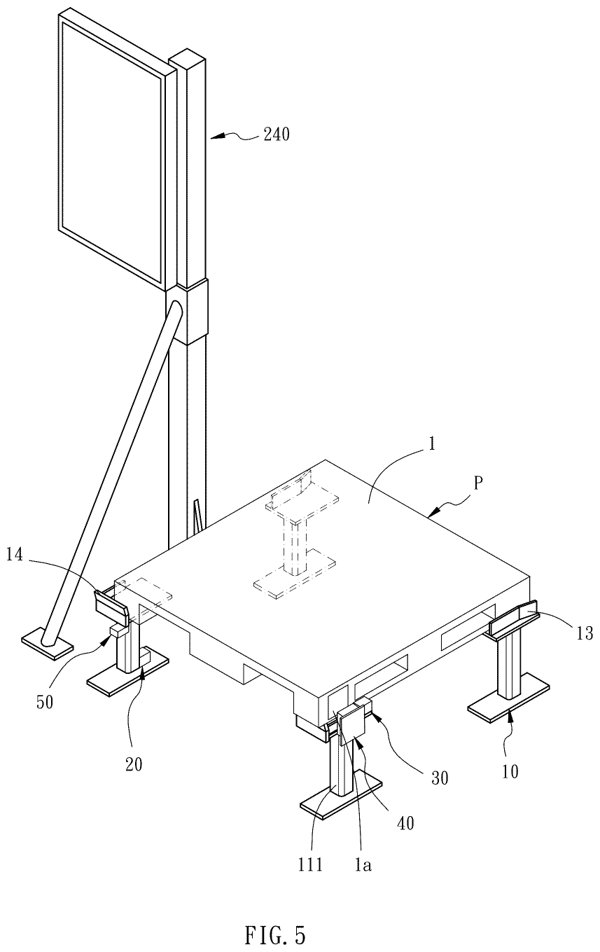

Referring to FIG. 4 and FIG. 5, in another embodiment, the pallet transfer mechanism 100 comprises a barcode reader 40 vertically disposed on one side of the periphery of the placement member 112. The barcode reader 40 is used to read a barcode 1a on the pallet 1, such that the barcode reader 40 senses the barcode 1a to confirm if the cargo information on the pallet 1 is correct, ensuring that the transfer process of the pallet 1 is smoother and reducing the possibility of errors during the transfer operation.

Referring to FIG. 4 and FIG. 5, in another embodiment, the pallet transfer mechanism 100 comprises a forklift sensor 50 disposed on the bottom face of the placement member 112. The forklift sensor 50 detects if there is a forklift on one side of the placement device 10 along the horizontal direction, and accordingly sends a forklift-existing signal or a no-forklift signal. Therein, if the forklift sensor 50 detects the forklift, the forklift sensor 50 sends the forklift-existing signal; if no forklift is detected, the forklift sensor 50 sends the no-forklift signal. Since the forklift is typically used for the shipping process of the pallet 1, the forklift sensor 50 is usually disposed on the pallet transfer mechanism 100 at the shipping position.

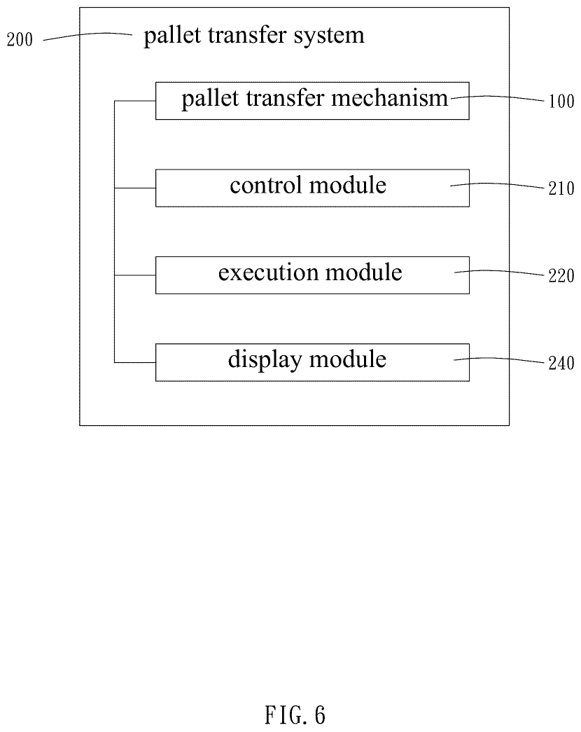

Referring to FIG. 6, in the embodiment, the present disclosure provides a pallet transfer system 200, which controls the operation of the aforementioned transportation devices based on the sensing conditions of the pallet transfer mechanism 100. The pallet transfer system 200 comprises the pallet transfer mechanism 100, a control module 210, and an execution module 220.

The control module 210 is coupled with the obstacle sensor 20 and the pallet sensor 30. When the control module 210 is used to control the pallet transfer mechanism 100 at the inbound position, if the control module 210 receives the no-obstacle signal and the no-pallet signal, the control module 210 outputs an automated guided vehicle inbound pallet placement signal; if the control module 210 receives the no-obstacle signal and the pallet-existing signal, the control module 210 outputs a stacker crane inbound pallet pickup signal. When the control module 210 is used to control the pallet transfer mechanism 100 at the outbound position, if the control module 210 receives the no-obstacle signal and the no-pallet signal, the control module 210 outputs a stacker crane outbound pallet placement signal; if the control module 210 receives the no-obstacle signal and the pallet-existing signal, the control module 210 outputs an automated guided vehicle outbound pallet pickup signal.

The execution module 220 is coupled with the obstacle sensor 20, the pallet sensor 30, and the control module 210. The execution module 220 is configured to receive the automated guided vehicle inbound pallet placement signal, the automated guided vehicle outbound pallet pickup signal, the stacker crane inbound pallet pickup signal, and the stacker crane outbound pallet placement signal, and accordingly control operation of the automated guided vehicle and the stacker crane. With such configuration, the control module 210 and the execution module 220, based on the signal sent by the obstacle sensor 20 and the pallet sensor 30, confirms if the automated guided vehicle and the stacker crane are allowed to enter the pallet transfer mechanism 100 for placing or picking up the pallet 1, and accordingly controls the operation of the automated guided vehicle and the stacker crane.

More specifically, taking the pallet transfer mechanism 100 disposed at the inbound position as an example, if the control module 210 receives the aforementioned no-obstacle signal and the no-pallet signal, the control module 210 outputs the automated guided vehicle inbound pallet placement signal to the execution module 220, and the execution module 220 controls the automated guided vehicle to place the pallet 1 at the handover position P. When the automated guided vehicle finishes the placement of the pallet 1 and leaves the handover space 12 (The obstacle sensor 20 first changes from sending the no-obstacle signal to sending the obstacle-existing signal, and then changes from sending the obstacle-existing signal back to sending the no-obstacle signal, while the pallet sensor 30 changes from sending the no-pallet signal to sending the pallet-existing signal), the control module 210 receives the no-obstacle signal and the pallet-existing signal, and accordingly outputs the stacker crane inbound pallet pickup signal to the execution module 220, such that the execution module 220 controls the stacker crane to take the pallet 1 at the handover position P and place the pallet 1 at the vacancy in the ASRS.

Referring to FIG. 6, in the embodiment, the control module 210 stores an abnormal warning time. If the duration of the obstacle-existing signal or pallet-existing signal remains for a time longer than the abnormal warning time, the control module 210 sends an abnormal signal to notify the user for troubleshooting.

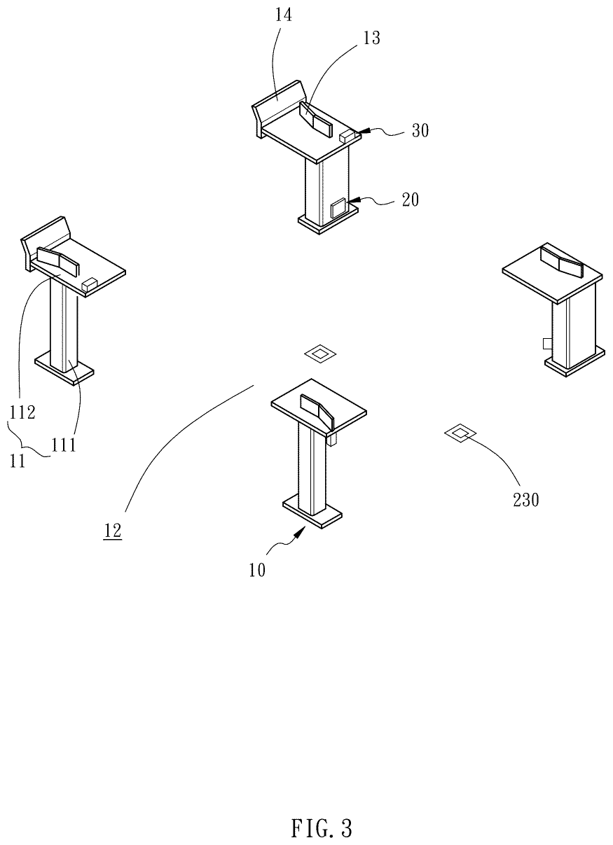

Referring to FIG. 3 and FIG. 6, in the embodiment, the pallet transfer system 200 comprises a positioning point 230, which is arranged on one side of the placement device 10 and within the handover space 12. The positioning point 230 is used for the automated guide vehicle to perform a positioning operation, allowing the automated guide vehicle to move to the correct position. Therein, when the automated guide vehicle is positioned at the positioning point 230 on the side of the placement device 10, the automated guide vehicle sends an inquiry signal to the control module 210 to reconfirm whether there is still an obstacle or pallet 1 in the handover space 12, so as to further ensure the transportation and transfer accuracy of the pallet 1, thereby improving the overall pallet transportation efficiency.

Referring to FIG. 4 to FIG. 6, in another embodiment of the present disclosure, when the control module 210 is used to control the pallet transfer mechanism 100 at the shipping position, if the control module 210 receives the no-obstacle signal and the no-pallet signal, the control module 210 outputs an automated guided vehicle warehouse exit pallet placement signal; if the control module 210 receives the no-obstacle signal and the pallet-existing signal, the control module 210 outputs a forklift warehouse exit pallet pickup signal. The execution module 220 receives the automated guided vehicle warehouse exit pallet placement signal and the forklift warehouse exit pallet pickup signal, and accordingly controls the operation of the automated guided vehicle and the forklift. With such configuration, when the pallet transfer mechanism 100 is used for shipping goods, the pallet transfer system 200 is able to control the operation of the automated guided vehicle and the forklift based on the aforementioned conditions, ensuring the transportation and transfer accuracy of the pallet 1.

Furthermore, the control module 210 is coupled with the forklift sensor 50. When the automated guided vehicle is about to enter the handover space 12, if, upon the no-obstacle signal and the no-pallet, the control module 210 simultaneously receives the no-forklift signal, the control module 210 outputs the automated guided vehicle warehouse exit pallet placement signal, such that the automated guided vehicle enters the handover space 12. If the control module 210 receives the forklift-existing signal, and the duration of it exceeds the aforementioned abnormal warning time, the control module 210 sends the abnormal signal to notify the user for troubleshooting.

Referring to FIG. 4 to FIG. 6, in another embodiment, the pallet transfer system 200 comprises a display device 240 coupled with the control module 210 and the execution module 220. The display device 240 is configured to display a pallet information of the pallet 1. Therein, the pallet information is allowed to include the cargo information identified by the barcode reader 40, and the information of whether the pallet 1 is positioned at the handover position P.

With the foregoing configuration, advantages of the present disclosure will be illustrated below.

The pallet transfer mechanism 100 of the present disclosure does not have a physical connection with the aforementioned transportation devices, allowing for positional adjustments according to practical needs and the available space of the automated storage and retrieval system, providing greater flexibility in warehouse space adjustment and utilization, thereby improving the overall efficiency of cargo transportation.

Each sensors of the pallet transfer mechanism 100 is able to accurately monitor the moving status and the placement status of the object in the mechanism, so that the present disclosure further ensures the transportation and transfer accuracy of the pallet 1.

Furthermore, the modules and devices of the pallet transfer system 200 in the present disclosure work in a stable and precise collaboration to control the movement and operation of various transportation devices, ensuring a transportation and transfer accuracy of the pallet 1.

Although particular embodiments of the disclosure have been described in detail for purposes of illustration, various modifications and enhancements may be made without departing from the scope of the disclosure. Accordingly, the disclosure is not to be limited except as by the appended claims.

What is claimed is:

1. A pallet transfer mechanism for placing a pallet thereon and allowing different transportation devices to hand over the pallet 1, the pallet transfer mechanism comprises:
a placement device having a plurality of brackets arranged in a circular manner at intervals to form a handover space, each of the brackets having a support member and a placement member, the placement member disposed on a top end of the support member and configured to place the pallet thereon;
an obstacle sensor disposed on the support member of one of the brackets, the obstacle sensor emitting an obstacle sensing beam in a diagonal direction across the handover space toward another one of the diagonally disposed brackets, the obstacle sensing beam being used to determine whether there is an object within the handover space, and the obstacle sensor accordingly sending an obstacle-existing signal or a no-obstacle signal; and
a pallet sensor disposed on the placement member of one of the brackets, the pallet sensor emitting a pallet sensing beam in a horizontal direction toward another one of the adjacent brackets, the pallet sensing beam being used to determine whether the pallet is placed on the placement member, and the pallet sensor accordingly sending a pallet-existing signal or a no-pallet signal.

2. The pallet transfer mechanism of claim 1, wherein the placement device comprises a plurality of guidance members and a block member; each of the guidance members is vertically disposed on the corresponding placement member; the guidance members are used to restrict the pallet at a handover position; the block member is vertically disposed on one side of a periphery of the placement member, so as to restrict the pallet at the handover position.

3. The pallet transfer mechanism of claim 1, wherein two obstacle sensors are included and disposed on the support member of two of the adjacent brackets; the two obstacle sensing light beams are emitted in a crossed pattern.

4. The pallet transfer mechanism of claim 1, wherein the pallet transfer mechanism comprises a barcode reader and a forklift sensor; the barcode reader is vertically disposed on one side of a periphery of the placement member, and configured to read a barcode of the pallet; the transportation devices include a forklift, and the forklift sensor is disposed on a bottom face of the placement member; the forklift sensor is configured to detect if there is a forklift on one side of the placement device along a horizontal direction, and accordingly send a forklift-existing signal or a no-forklift signal.

5. A pallet transfer system for different transportation devices to hand over a pallet, the transportation device comprising an automated guided vehicle and a stacker crane, the pallet transfer system comprising:
a pallet transfer mechanism disposed at an inbound position or an outbound position, the pallet transfer mechanism comprising:
a placement device having a plurality of brackets arranged in a circular manner at intervals to form a handover space, the brackets being used to place the pallet thereon, each of the brackets having a support member and a placement member, the placement member disposed on a top end of the support member and configured to place the pallet thereon;
an obstacle sensor disposed on one of the brackets, the obstacle sensor emitting an obstacle sensing beam in a diagonal direction across the handover space toward another one of the diagonally disposed brackets, the obstacle sensing beam being used to determine whether there is an object within the handover space, and the obstacle sensor accordingly sending an obstacle-existing signal or a no-obstacle signal; and
a pallet sensor disposed on one of the brackets, the pallet sensor emitting a pallet sensing beam in a horizontal direction toward another one of the adjacent brackets, the pallet sensing beam being used to determine whether the pallet is placed on the placement member, and the pallet sensor accordingly sending a pallet-existing signal or a no-pallet signal;
a control module coupled with the obstacle sensor and the pallet sensor; when the control module is used to control the pallet transfer mechanism at the inbound position, if the control module receives the no-obstacle signal and the no-pallet signal, the control module outputs an automated guided vehicle inbound pallet placement signal; if the control module receives the no-obstacle signal and the pallet-existing signal, the control module outputs a stacker crane inbound pallet pickup signal; when the control module is used to control the pallet transfer mechanism at the outbound position, if the control module receives the no-obstacle signal and the no-pallet signal, the control module outputs a stacker crane outbound pallet placement signal; if the control module receives the no-obstacle signal and the pallet-existing signal, the control module outputs an automated guided vehicle outbound pallet pickup signal; and
an execution module coupled with the obstacle sensor, the pallet sensor, and the control module, the execution module configured to receive the automated guided vehicle inbound pallet placement signal, the automated guided vehicle outbound pallet pickup signal, the stacker crane inbound pallet pickup signal, and the stacker crane outbound pallet placement signal, and accordingly control operation of the automated guided vehicle and the stacker crane.

6. The pallet transfer system of claim 5, wherein the placement device comprises a plurality of guidance members and a block member; each of the guidance members is vertically disposed on the corresponding placement member; the guidance members are used to restrict the pallet at a handover position; the block member is vertically disposed on one side of a periphery of the placement member, so as to restrict the pallet at the handover position.

7. The pallet transfer system of claim 5, wherein two obstacle sensors are included and disposed on the support member of two of the adjacent brackets; the two obstacle sensing light beams are emitted in a crossed pattern.

8. The pallet transfer system of claim 5, wherein the control module stores an abnormal warning time; if a duration of the obstacle-existing signal or the pallet-existing signal remains for a time longer than the abnormal warning time, the control module sends an abnormal signal.

9. The pallet transfer system of claim 5, wherein the transportation devices comprises a forklift, and the pallet transfer mechanism is allowed to be disposed at a shipping position; when the control module is used to control the pallet transfer mechanism at the shipping position, if the control module receives the no-obstacle signal and the no-pallet signal, the control module outputs an automated guided vehicle warehouse exit pallet placement signal;
if the control module receives the no-obstacle signal and the pallet-existing signal, the control module outputs a forklift warehouse exit pallet pickup signal; the execution module receives the automated guided vehicle warehouse exit pallet placement signal and the forklift warehouse exit pallet pickup signal, and accordingly controls the operation of the automated guided vehicle and an operation of the forklift.

10. The pallet transfer system of claim 9, wherein the pallet transfer mechanism comprises a barcode reader and a forklift sensor; the barcode reader is vertically disposed on one side of a periphery of the placement member; the barcode reader is configured to read a barcode of the pallet; the forklift sensor is disposed on a bottom face of the placement member; the forklift sensor is configured to detect if there is a forklift on one side of the placement device along a horizontal direction, and accordingly send a forklift-existing signal or a no-forklift signal; the pallet transfer system comprises a display device coupled with the control module and the execution module; the display device is configured to display a pallet information of the pallet.
